(19) United States
(12) Patent Application Publication
(10) Pub. No.: US 2024/0394453 A1
(43) Pub. Date: Nov. 28, 2024

(54) GLOBAL PLACEMENT OF CIRCUIT DESIGNS USING A CALIBRATED SIMPLE TIMER

(71) Applicant: Xilinx, Inc., San Jose, CA (US)

(72) Inventors: Wuxi Li, San Bruno, CA (US); Ismail Bustany, San Carlos, CA (US); Yuji Kukimoto, Sunnyvale, CA (US); Mehrdad Eslami Dehkordi, Los Gatos, CA (US)

(73) Assignee: Xilinx, Inc., San Jose, CA (US)

(21) Appl. No.: 18/202,465

(22) Filed: May 26, 2023

(51) Int. Cl. G06F 30/392; G06F 30/31; G06F 30/3312

(52) U.S. Cl. CPC G06F 30/392; G06F 30/31; G06F 30/3312; G06F 2119/12

(57) ABSTRACT

A design tool calibrates current delays of timing arcs in a current placement of a circuit design by determining respective delta-delays of the timing arcs. The current placement is represented by timing nodes connected by the timing arcs in a graph. The calibrating is based on a first timer model indicating arrival times at the timing nodes based on timing propagation without accounting for timing exceptions, and a reference timer indicating slacks that account for timing exceptions at the timing nodes. The design tool updates the current delays of the timing arcs using the delta-delays and delays from the first timer model and updates the current placement based on the current delays. The updating of the current delays and updating of the current placement are repeated in response to failure to satisfy placement convergence criteria.

### TECHNICAL FIELD

The disclosure generally relates to global placement of circuit designs using a calibrated simple timer.

### BACKGROUND

Placement is an integral step in realizing a circuit implementation from a circuit design. Timing-driven placement approaches are directed to reducing delays on timing-critical paths. However, blindly optimizing some targeted critical paths can often degrade the timing of other paths, which may even degenerate non-critical paths into critical paths.

### SUMMARY

A disclosed method includes calibrating current delays of timing arcs in a current placement of a circuit design by a design tool. The design tool calibrates by determining respective delta-delays of the timing arcs. The current placement is represented by a plurality of timing nodes connected by the timing arcs in a graph, and the calibrating is based on a first timer model indicating arrival times at the timing nodes based on timing propagation without accounting for timing exceptions, and a reference timer indicating slacks that account for timing exceptions at the timing nodes. The method includes the design tool updating the current delays of the timing arcs using the delta-delays and delays from the first timer model. The method includes updating the current placement by the design tool based on the current delays and repeating updating of the current delays and updating of the current placement in response to failure to satisfy placement convergence criteria.

A disclosed system includes one or more computer processors configured to execute program code and a memory arrangement coupled to the one or more computer processors. The memory arrangement is configured with instructions of a design tool that when executed by the one or more computer processors cause the one or more computer processors to perform operations including calibrating current delays of timing arcs in a current placement of a circuit design by determining respective delta-delays of the timing arcs. The current placement is represented by a plurality of timing nodes connected by the timing arcs in a graph, and the calibrating is based on a first timer model indicating arrival times at the timing nodes based on timing propagation without accounting for timing exceptions, and a reference timer indicating slacks that account for timing exceptions at the timing nodes. The operations include updating the current delays of the timing arcs using the delta-delays and delays from the first timer model and updating the current placement based on the current delays. The operations of updating the current delays and updating the current placement are repeated in response to failure to satisfy placement convergence criteria.

Other features will be recognized from consideration of the Detailed Description and Claims, which follow.

### BRIEF DESCRIPTION OF THE DRAWINGS

Various aspects and features of the methods and systems will become apparent upon review of the following detailed description and upon reference to the drawings in which:

FIG. 1 is a flowchart of a process in which a simple timer is calibrated to a reference timer during global placement;

FIG. 2 shows an example of a graphical representation of a portion of a circuit design; and

FIG. 3 is a block diagram illustrating an exemplary data processing system.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

Simple (or “basic”) timers and reference timers, as functions called by a design tool, have been used during the placement phase of a design flow to gauge how closely a placement comes to satisfying timing objectives. The simple timer can complete quickly relative to the reference timer. However, the simple timer provides timing estimations that are less accurate than those provided by the reference timer. The reference timer produces more accurate timing estimations by employing complex algorithms and is therefore compute intensive, in that the algorithm accounts for numerous exceptions in estimating delays. Examples of exceptions include clock re-convergence pessimism removal (CRPR), false paths, multi-cycle paths, multi-clock domains, and user-defined maximum and minimum delay constraints. The simple timer uses a simple timer model that indicates delays of wires that could connect source and sink pins based on placement of the pins.

According to the disclosed methods and systems, a timing calibration technique correlates a simple timer to a reference timer, and the calibrated simple timer is used during global placement. The calibrated simple timer can be used in combination with a non-linear differentiable timing-driven global placement framework. Compared with prior techniques, the disclosed approach can produce a globally placed design having a greater maximum frequency and a lesser wirelength, and do so in a much shorter runtime.

The disclosed timing-driven placement approach calibrates a simple timer with a reference timer based on delays of timing arcs from a simple timer model and slacks indicated by a reference timer at each timing node. The simple timer supports basic timing propagation and does not account for timing exceptions. The reference timer to which the simple timer is calibrated supports static timing analysis with advanced features of clock re-convergence pessimism removal (CRPR) and accounts for timing exceptions. The global placement process correlates the simple timer to the reference timer through a calibration process, and once calibrated the placement process uses the simple timer for timing optimization. During the placement process, the simple timer can be periodically calibrated with the reference timer to account for changes in placement. A fast runtime achieved is by using the calibrated simple timer in global placement, with the timing estimations produced by the simple timer being highly accurate as a result of calibrating to the reference timer.

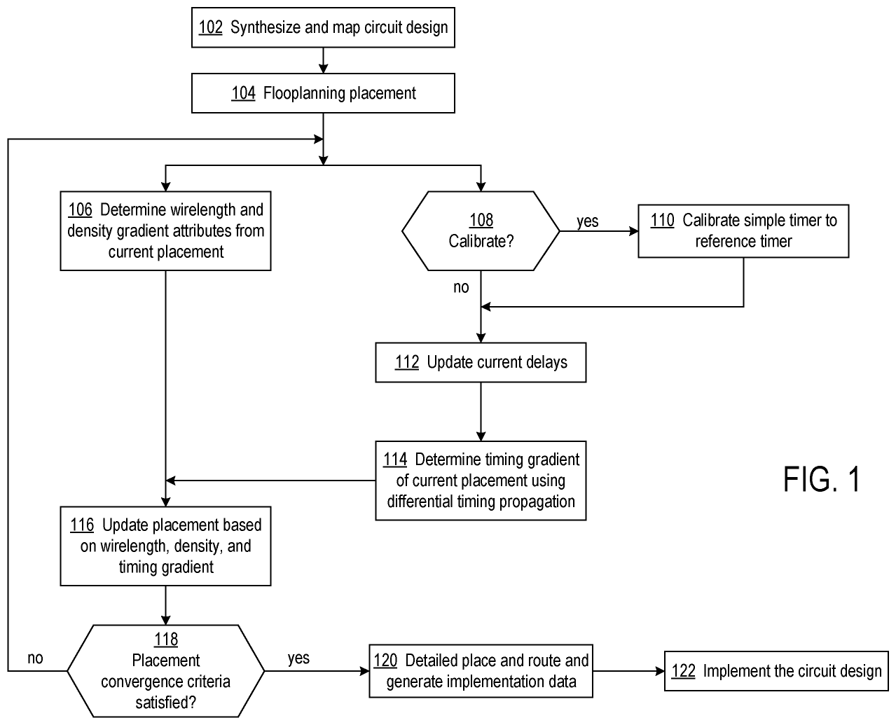

FIG. 1 is a flowchart of a process in which a simple timer is calibrated to a reference timer during global placement. During global placement, the design tool iteratively updates locations of elements of a circuit design based on wirelength, density, and timing gradients, in a non-linear optimization setting. A simple timer is calibrated to a reference timer and provides timing estimations to a differential timing propagation process to compute the timing gradient.

At block 102, a design tool synthesizes and maps a circuit design to elements of a target integrated circuit (IC). The target IC can be an application specific integrated circuit (ASIC), a field programmable gate array (FPGA), or a system-on-chip (SoC) or system-in-package (SiP) that includes either or a combination of ASIC and FPGA circuitry. At block 104, the design tool generates an initial placement using floorplanning approaches.

The design tool commences global placement at blocks 106 and 108 and iteratively updates the placement based on wirelength, density gradient, and timing gradient at block 116 until placement convergence criteria have been satisfied at decision block 118. The timing gradient is determined using the calibrated simple timer, and the wirelength and density gradient can be determined using known approaches.

The design tool can calibrate the simple timer to the reference timer multiple times during the iterative placement process. According to one approach, the simple timer can be calibrated once every N iterations, where N can be selected by the designer to compromise between accuracy and placement runtime. A lesser value of N would increase accuracy of the simple timer and increase placement runtime, and a greater value of N would decrease accuracy of the simple timer and decrease placement runtime.

According to another approach, which can be used alone or in combination with calibrating once every N iterations, the design tool can calibrate the simple timer to the reference timer in response to the magnitude of change in locations between iterations exceeding a threshold. For example, x can represent a vector of locations of elements in a current placement produced by the most recent iteration, and x*can represent a vector of locations of elements in a placement resulting from the iteration at which the simple timing was last calibrated. In response to “the p-norm,” ∥x−x*∥^{p}, being greater than a threshold, where p is a model-dependent wire delay constant, the design tool can proceed to calibrate the simple timer. The value of p can be selected based on the type of wire delay model. For a linear wire delay mode, p can be 1, and for a quadratic wire delay model, p can be 2. The x*vector can then be used as the x vector in subsequent iterations. The magnitude of change in locations can be evaluated once every N iterations.

At decision block 108, the design tool determines whether or not to calibrate the simple timer as described above. In response to determining that the simple timer should be calibrated, the design tool proceeds to block 110 to calibrate the simple timer to the reference timer. Otherwise, calibration is bypassed in the current iteration.

The simple timer represents the placed circuit design as a graph of timing nodes connected by timing arcs. The timing nodes are associated with pins of the circuit design. A timing node can be associated with a pin in the circuit design or be associated with a node internal to an element of the circuit design. Some pins of the circuit design do not need associated timing nodes for placement, and other pins can have 1 or more associated timing nodes. The timing arcs represent signal connections between the timing nodes consistent with the netlist. In calibrating the simple timer, the design tool determines for each timing arc, an amount (referred to herein as a “delta delay”) by which the delay provided by the simple timer model can be adjusted at block 112. The following notation is used in describing the calibration algorithm:
ST—simple timer
RT—reference timer
V—the set of all timing nodes
Vₛₜₐᵣₜ—the set of path-start timing nodes
V_{end}—the set of path-end timing nodes
E—the set of all timing arcs
AAT—actual arrival time at timing node in ST
RAT—required arrival time at timing node in ST
SLK—slack at timing node in ST
SLK*—slack at timing node in RT
DLY—timing arc model delay in ST
ΔDLY—timing arc delta-delay resulting from calibration

The calibration approach can be formally described as follows. Given a timing graph having timing node u annotated with AATᵤ(from the ST) and SLKᵤ* (from the RT), u∈V, the calibration computes RATᵤ, u∈V_{end}, and ΔDLYₑ, e∈E, such that SLKᵤ can exactly match SLKᵤ*, ∀u∈V, when DLYₑ+ΔDLYₑ, instead of DLYₑ, e∈E, are used as timing arc delays in ST. Note that matching of slacks is attempted but not matching of AATs or RATs, because 1) the worst slack at each timing node can solely define its timing criticality, but AAT or RAT cannot; and 2) the worst slack at each timing node is a continuous function with respect to physical locations of elements, but AAT or RAT corresponding to worst slacks do not, in general, have this property when there exist timing exceptions. Reason 1 implies that slack is a more relevant metric for timing modeling than AAT and RAT, and reason 2 suggests that slack is more amenable to numeric optimization due to its continuity, which is important for differentiable timing optimization.

Algorithm 1 describes the calibration process. The input parameters to the algorithm include: DLYₑ, e∈E, from the delay model in ST; and SLK*ᵤ, u∈V, from RT. The outputs from the algorithm are ΔDLYₑ, e∈E, and RATᵤ, U∈V_{end}, such that SLKᵤ=SLK*ᵤ, ∀u∈V, if DLY+ΔDLY is used in ST.

Algorithm 1

| | |
|---|---|
| 1 | AATᵢ ← 0, ∀ i ∈ Vₛₜₐᵣₜ; |
| 2 | for each i ∈ V in forward-topological order do |
| 3 | AATᵢ ← max_{j ∈ fan-in(i)}{AATⱼ + DLY_{j,i}} |
| 4 | for each i ∈ V in backward-topological order do |
| 5 | RATᵢ ← AATᵢ + SLK*ᵢ; |
| 6 | for each j ∈ fan-in(i) do |
| 7 | ΔDLY_{j,} ←RATᵢ − DLY_{j,} − AATⱼ − max(SLK*ⱼ, SLK*ᵢ); |

In line 1, the AAT's of all path-start timing nodes are initialized to 0. In lines 2-3, a regular forward propagation is performed to compute the AAT's of all timing nodes using delay values (DLY) from the simple timer model using a multi-variate maximum (i.e., max among more than two values). For each timing node i, AATᵢ is assigned the maximum of the sums of the AAT's of the fan-in timing nodes plus the DLY's of the timing arcs from the fan-in timing nodes to timing node i.

In lines 4-7, the RAT of each timing node and the delta-delay, ΔDLY, of each timing arc are computed through a backward propagation. In line 5, the RAT of timing node i is assigned the sum of AATᵢ and SLK*ᵢ. Lines 6 and 7 compute the ΔDLY for each fan-in timing arc to timing node i.

The formula of ΔDLY in line 7 can be obtained based on whether timing node i is a net driver or a net load and relevant slack values. In case 1, SLK*ⱼ≥SLK* which is a common case when timing node is a net driver (SLK*ⱼ may not always be ≥SLK*ᵢ when i is a net driver). In case 2, SLK*ⱼ≤SLK*ᵢ, which is a common case when timing node i is a net load. In case 1, it can be assumed that RATj (timing node j is a fan-in to timing node i) is determined by RATi, which provides the following derivation of ΔDLY for the timing arc from timing node j to timing node i:

RATⱼ = RATᵢ − DLY_{j,} − ΔDLY_{j,}
ΔDLY_{j,} = RATᵢ − DLY_{j,} − RATⱼ
ΔDLY_{j,} = RATᵢ − DLY_{j,} − (AATⱼ + SLK*ⱼ)
ΔDLY_{j,} = RATᵢ − DLY_{j,} − AATⱼ − SLK*ⱼ

In case 2, it can be assumed that the AAT of timing node i is determined by the AAT of timing node j, which provides the following derivation:

AATᵢ = AATⱼ + DLYⱼ, + ΔDLY_{j,} ,
ΔDLY_{j,} = AATᵢ − AATⱼ − DLY_{j,} ,
ΔDLY_{j,} = (RATᵢ − SLK*ᵢ) − AATⱼ − DLY_{j,} ,
ΔDLY_{j,i} = RATᵢ − DLY_{j,i} − AATⱼ − SLK*ᵢ

At block 112, the design tool updates the current delays associated with the timing arcs based on the current placement, the delays provided by the simple timer model, and the delta-delays that calibrate the timing arcs. The current delay of a timing arc between a source timing node and a sink timing node is a sum of the simple timer model delay of each wire on a path from the source timing node to the sink timing node, as indicated by the placement, and the delta-delay associated with the timing arc.

At block 114, the design tool performs timing propagation in ST in a differentiable manner, which quantifies the sensitivity of the timing objective with respect to each timing arc delay. The final timing gradient then can be computed by assembling the quantified sensitivities. The design tool updates the placement at block 116 based on the wirelength, density gradient, and timing gradient.

The design tool determines at decision block 118 whether or not placement convergence criteria have been satisfied. The placement convergence criteria can include metrics that quantify wirelength, density, and timing, all of which can be determined by known methods of current design tools. The design tool continues at blocks 106 and 108 to perform another placement iteration in response to the current placement failing to satisfy the placement convergence criteria. Once the placement convergence criteria are satisfied, the design tool can proceed to the next phase of the design flow.

At block 120, the design tool performs detailed placement and routing of the actual elements in the circuit design and generates implementation data. For example, place-and-route and bitstream generation tools may be executed to generate configuration data for an FPGA. Other tools can generate configuration data from which an application-specific (ASIC) can be fabricated. At block 122, a circuit can be implemented by way of configuring a programmable IC with the configuration data or fabricating, making, or producing an ASIC from the configuration data, thereby creating a circuit that operates according to the resulting circuit design.

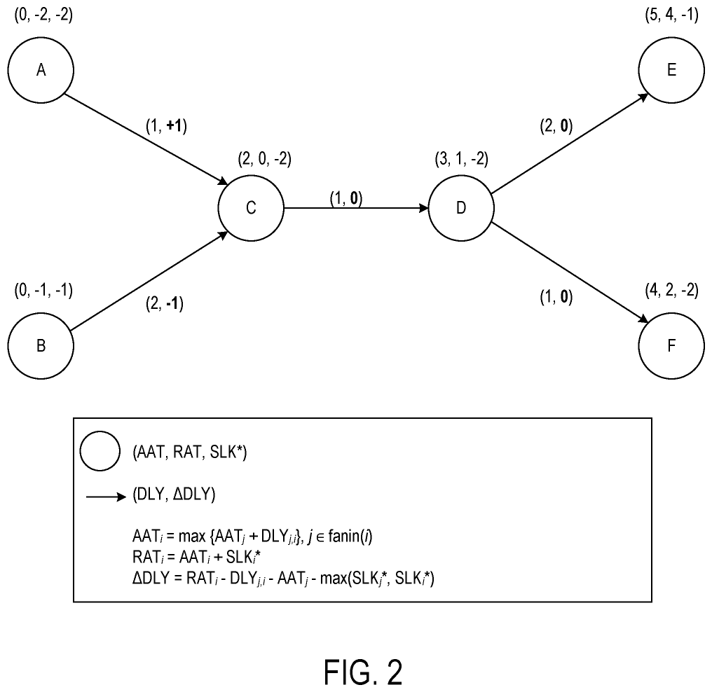

FIG. 2 shows an example of a graphical representation of a portion of a circuit design and the result of calibrating delays of timing arcs indicated by a simple timer model to a reference timer. The timing nodes are labeled A, B, C, D, E, and F, and each timing node is labeled with the associated AAT, RAT, and SLK*. Each of the timing arcs is labeled with the associated DLY and ΔDLY values.

Using timing node C as an example, AAT_{C} (AAT_{C}=2) results from AAT_{B}+DLY_{B,C} (AAT_{B}=0, DLY_{B,C}=2) in the forward propagation of lines 2-3 of the calibration algorithm. Note, however, that the timing arc (A, C) is actually more critical than (B, C), because SLK*_{A}<SLK*_{B} according to the reference timer.

The calibration algorithm adjusts ΔDLY_{A,C} and ΔDLY_{B,C} (“delta-delays”) to compensate for the fact that SLK*_{A}<SLK*_{B} and the simple timer model delay DLY_{A,C}<DLY_{B,C}. The calibration algorithm (lines 4-7), in this example, generates ΔDLY_{A,C} (ΔDLY_{A,C}=+1) that increases the effective delay of (A,C), and generates ΔDLY_{B,C} (ΔDLY_{B,C}=−1) that decreases the effective delay of (B,C). The ΔDLY values reflect the actual relative criticality from the reference timer.

The disclosed calibration approaches have three notable properties: 1) The calibrated simple timer can exactly match the slacks from the reference timer (i.e., SLKᵢ=SLKᵢ*, ∀ᵢ∈V) at the placement at which the calibration is performed. 2) The slack error from the calibrated simple timer at placement x, where x a vector of element locations, is bounded by O(∥x−x*∥^{p}), where x is a previous placement, x* denotes the placement where the calibration is conducted, and p is a constant depends on the simple timer wire delay model. 3) Most placement-invariant timing information can be exactly captured by the calibration.

Property 2 is based on the fact that the worst slack at each timing node is a continuous function of timing arc delays, and timing arc delays are continuous functions of element locations. Therefore, the slack error is continuous to and bounded by the placement perturbation O(∥x−x*∥^{p}), where p=1 for a linear wire delay model, and p=2 for a quadratic wire delay model. Property 1 and Property 2 together imply that the calibrated simple timer is a continuous and error-bounded approximation of the reference timer around x*, which is essential to differentiable timing optimization.

Property 3 enables the simple timer to consume significantly fewer computational resources than the reference timer. There are many sources of inaccuracy in the simple timer that are placement-invariant. That is, the mismatch between the simple timer and the reference timer in regards to the placement-invariant inaccuracies is constant, regardless of the placement. For example, intra-element timing arc delays and multiplexing/switchbox wiring overhead in an FPGA can be treated as constants in global placement. Furthermore, some common timing exceptions, such as multi-clock domains and multi-cycle paths, are also placement-invariant as those exceptions are inherent logical properties of the netlist. For example, timing exceptions, such as multi-cycle paths, are independent of a placement change as the multi-cycle paths are inherent logical properties of the netlist.

Property 3 implies that these placement-invariant timing factors do not need to be modeled in the simple timer, because the placement-invariant timing factors all can be exactly captured by the calibration.

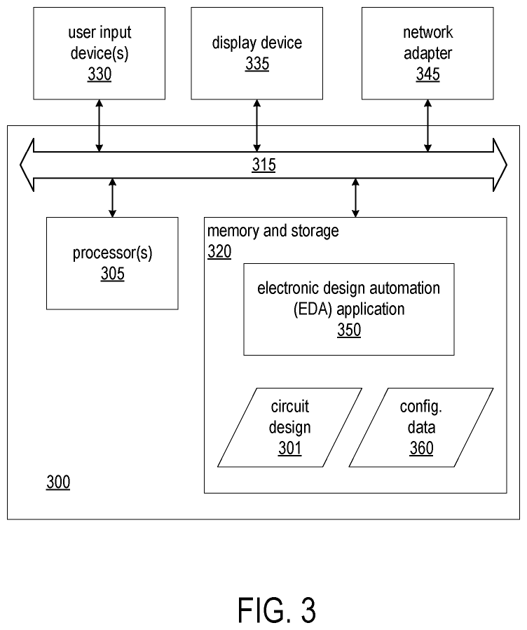

FIG. 3 is a block diagram illustrating an exemplary data processing system (system) 300. System 300 is an example of an EDA system. As pictured, system 300 includes at least one processor circuit (or “processor”), e.g., a central processing unit (CPU) 305 coupled to memory and storage arrangement 320 through a system bus 315 or other suitable circuitry. System 300 stores program code and circuit design 301 within memory and storage arrangement 320. Processor 305 executes the program code accessed from the memory and storage arrangement 320 via system bus 315. In one aspect, system 300 is implemented as a computer or other data processing system that is suitable for storing and/or executing program code. It should be appreciated, however, that system 300 can be implemented in the form of any system including a processor and memory that is capable of performing the functions described within this disclosure.

Memory and storage arrangement 320 includes one or more physical memory devices such as, for example, a local memory (not shown) and a persistent storage device (not shown). Local memory refers to random access memory or other non-persistent memory device(s) generally used during actual execution of the program code. Persistent storage can be implemented as a hard disk drive (HDD), a solid state drive (SSD), or other persistent data storage device. System 300 may also include one or more cache memories (not shown) that provide temporary storage of at least some program code and data in order to reduce the number of times program code and data must be retrieved from local memory and persistent storage during execution.

Input/output (I/O) devices such as user input device(s) 330 and a display device 335 may be optionally coupled to system 300. The I/O devices may be coupled to system 300 either directly or through intervening I/O controllers. A network adapter 345 also can be coupled to system 300 in order to couple system 300 to other systems, computer systems, remote printers, and/or remote storage devices through intervening private or public networks. Modems, cable modems, Ethernet cards, and wireless transceivers are examples of different types of network adapter 345 that can be used with system 300.

Memory and storage arrangement 320 may store an EDA application 350. EDA application 350, being implemented in the form of executable program code, is executed by processor(s) 305. As such, EDA application 350 is considered part of system 300. System 300, which is configured as a design tool while executing EDA application 350, receives and operates on circuit design 301. In one aspect, system 300 performs a design flow on circuit design 301. In one aspect, system 300 performs a design flow on circuit design 301, and the design flow may include synthesis, mapping, placement, routing, and generation of configuration data 360 from which an integrated circuit can be made.

EDA application 350, circuit design 301, circuit design 301, configuration data 360 and any data items used, generated, and/or operated upon by EDA application 350 are functional data structures that impart functionality when employed as part of system 300 or when such elements, including derivations and/or modifications thereof, are loaded into an IC such as a programmable IC causing implementation and/or configuration of a circuit design within the programmable IC.

Though aspects and features may in some cases be described in individual figures, it will be appreciated that features from one figure can be combined with features of another figure even though the combination is not explicitly shown or explicitly described as a combination.

The methods and systems are thought to be applicable to a variety of systems for placing circuit designs. Other aspects and features will be apparent to those skilled in the art from consideration of the specification. The methods and system may be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. A method comprising:
calibrating current delays of timing arcs in a current placement of a circuit design by a design tool determining respective delta-delays of the timing arcs, wherein the current placement is represented by a plurality of timing nodes connected by the timing arcs in a graph, and the calibrating is based on a first timer model indicating arrival times at the timing nodes based on timing propagation without accounting for timing exceptions, and a reference timer indicating slacks that account for timing exceptions at the timing nodes;
updating the current delays of the timing arcs by the design tool using the delta-delays and delays from the first timer model;
updating the current placement by the design tool based on the current delays; and
repeating updating the current delays and updating the current placement in response to failure to satisfy placement convergence criteria.

2. The method of claim 1, wherein the calibrating includes determining the respective delta-delays once every N repetitions of determining the current delays and updating the current placement, for N≥1.

3. The method of claim 1, wherein the calibrating includes determining the respective delta-delays in response to a difference between the current placement and a previous placement being greater than a threshold.

4. The method of claim 1, wherein the calibrating includes:
determining a difference between the current placement and a previous placement once every N repetitions of determining the current delays and updating the current placement, for N≥1; and
determining the respective delta-delays in response to the difference being greater than a threshold.

5. The method of claim 1, further comprising:
determining a wirelength of the current placement;
determining a timing gradient of the current placement using differential timing propagation on the current delays; and
determining a density gradient of the current placement;
wherein updating the current placement includes moving elements of the circuit design in directions based on the wirelength, timing gradient, and density gradient.

6. The method of claim 1, wherein calibrating the current delays includes for each timing arc:
using a timing model of a target integrated circuit (IC) device to determine the current delay of the timing arc; and
summing the current delay and the delta-delay of the timing arc.

7. The method of claim 1, wherein the calibrating includes:
traversing the graph in forward topological order to determine respective actual arrival times of the timing nodes;
for each timing node j of one or more timing nodes in the graph that fan-in to timing node i in the graph, determining a respective sum of the actual arrival time of timing node j and a delay from timing node j to timing node i as indicated by the first timer model; and
assigning a maximum of respective sums determined for the one or more timing nodes that fan-in to timing node i, as the actual arrival time of timing node i.

8. The method of claim 7, wherein the calibrating includes:
traversing the graph in reverse topological order to determine respective required arrival times of the timing nodes based on the actual arrival times of the timing nodes and the slacks indicated by the reference timer;
for each timing node j of one or more timing nodes in the graph that fan-out to timing node i, determining the delta-delay of the timing arc from timing node j to timing node i in the graph as the respective required arrival time of timing node j less the current delay of the timing arc from timing node j to timing node i less the actual arrival time at timing node j and less a maximum of the slacks indicated by the reference timer for timing nodes j and i.

9. The method of claim 1, wherein:
the first timer model is a linear wire delay model; and
the calibrating includes determining the respective delta-delays in response to a p-norm, ∥x−x*∥^{p}, being greater than a threshold, for p=1, x=a vector of element locations in the current placement, and x*=a vector of element locations in a prior placement that resulted from prior respective delta-delays.

10. The method of claim 1, wherein:
the first timer model is a quadratic wire delay model; and
the calibrating includes determining the respective delta-delays in response to a p-norm, ∥x−x*∥^{p}, being greater than a threshold, for p=2, x=a vector of element locations in the current placement, and x*=a vector of element locations in a prior placement that resulted from prior respective delta-delays.

11. A system comprising:
one or more computer processors configured to execute program code; and
a memory arrangement coupled to the one or more computer processors, wherein the memory arrangement is configured with instructions of a design tool that when executed by the one or more computer processors cause the one or more computer processors to perform operations including:
calibrating current delays of timing arcs in a current placement of a circuit design by determining respective delta-delays of the timing arcs, wherein the current placement is represented by a plurality of timing nodes connected by the timing arcs in a graph, and the calibrating is based on a first timer model indicating arrival times at the timing nodes based on timing propagation without accounting for timing exceptions, and a reference timer indicating slacks that account for timing exceptions at the timing nodes;
updating the current delays of the timing arcs using the delta-delays and delays from the first timer model;
updating the current placement based on the current delays; and
repeating updating the current delays and updating the current placement in response to failure to satisfy placement convergence criteria.

12. The system of claim 11, wherein the instructions for calibrating include instructions for determining the respective delta-delays once every N repetitions of determining the current delays and updating the current placement, for N≥1.

13. The system of claim 11, wherein the instructions for calibrating include instructions for determining the respective delta-delays in response to a difference between the current placement and a previous placement being greater than a threshold.

14. The system of claim 11, wherein the instructions for calibrating include instructions for:
determining a difference between the current placement and a previous placement once every N repetitions of determining the current delays and updating the current placement, for N≥1; and
determining the respective delta-delays in response to the difference being greater than a threshold.

15. The system of claim 11, wherein the memory arrangement is configured with instructions that when executed by the one or more computer processors cause the one or more computer processors to perform operations including:
determining a wirelength of the current placement;
determining a timing gradient of the current placement using differential timing propagation on the current delays; and
determining a density gradient of the current placement;
wherein the instructions for updating the current placement include instructions for moving elements of the circuit design in directions based on the wirelength, timing gradient, and density gradient.

16. The system of claim 11, wherein the instructions for calibrating the current delays include, for each timing arc, instructions for:
using a timing model of a target integrated circuit (IC) device to determine the current delay of the timing arc; and
summing the current delay and the delta-delay of the timing arc.

17. The system of claim 11, wherein the instructions for calibrating include instructions for:
traversing the graph in forward topological order to determine respective actual arrival times of the timing nodes;
for each timing node j of one or more timing nodes in the graph that fan-in to timing node i in the graph, determining a respective sum of the actual arrival time of timing node j and a delay from timing node j to timing node i as indicated by the first timer model; and
assigning a maximum of respective sums determined for the one or more timing nodes that fan-in to timing node i, as the actual arrival time of timing node i.

18. The system of claim 17, wherein the instructions for calibrating include instructions for:
traversing the graph in reverse topological order to determine respective required arrival times of the timing nodes based on the actual arrival times of the timing nodes and the slacks indicated by the reference timer;
for each timing node j of one or more timing nodes in the graph that fan-out to timing node i, determining the delta-delay of the timing arc from timing node j to timing node i in the graph as the respective required arrival time of timing node j less the current delay of the timing arc from timing node j to timing node i less the actual arrival time at timing node j and less a maximum of the slacks indicated by the reference timer for timing nodes j and i.

19. The system of claim 11, wherein:
the first timer model is a linear wire delay model; and
the instructions for calibrating include instructions for determining the respective delta-delays in response to a p-norm, ∥x−x*∥^{p}, being greater than a threshold, for p=1, x=a vector of element locations in the current placement, and x*=a vector of element locations in a prior placement that resulted from prior respective delta-delays.

20. The system of claim 11, wherein:
the first timer model is a quadratic wire delay model; and
the instructions for calibrating include instructions for determining the respective delta-delays in response to a p-norm, ∥x−x*∥^{p}, being greater than a threshold, for p=2, x=a vector of element locations in the current placement, and x*=a vector of element locations in a prior placement that resulted from prior respective delta-delays.
